(19) United States
(12) Patent Application Publication
(10) Pub. No.: US 2012/0108274 A1
(43) Pub. Date: May 3, 2012

(54) Method and System of Communication That Allow People Unknown to Each Other Who Have Visual Contact to Communicate by SMS or E-mail

(76) Inventors: Agustin ACEBO RUIZ, Madrid (ES); José Ángel GRANADO CASTAÑO, Toledo (ES)

(21) Appl. No.: 12/913,103

(22) Filed: Oct. 27, 2010

(51) Int. Cl. H04W 4/00

(52) U.S. Cl. 455/466

(57) ABSTRACT

Method and system of communication that allow people unknown to each other who have visual contact, to communicate by sms or e-mail based on the identification of system users through the perception of codes of registered users, formed from the combination of graphic symbols that follow uniquely identifying coding rules for each user within the system, by use of a computer application that decodes said user codes and allows the delivery of messages between said users, ensuring maximum discretion during communication, both towards the rest of the environment and towards the user with whom one wishes to establish contact.

Method and system of communication that allow people unknown to each other who have visual contact, to communicate by sms or e-mail, based on a registered user code having a physical or electronic format and a web-based software.

### OBJECT OF THE INVENTION

The present invention relates to the field of social networks and provides a method allowing communication between people that do not know each other, through visual contact by using a user code perceivable by all other users and an web-based software.

The method according to the present invention allows two or more users, who are unknown to each other and therefore do not have the contact information of the other users (telephone number and e-mail address), to coincide in a same physical environment, thus having mutual visual contact and being carriers of registered user code composed of a set of symbols that uniquely identifies each user within the system, allowing communication to be established through mobile telephone messages or electronic mail, also allowing the receiver user of the message to answer the message from the first user or to reject it.

The method allows communication, based on the identification of system users through the perception of the codes of registered users, formed from the combination of graphic symbols that follow uniquely identifying coding rules for each user within the system, by use of a computer application that decodes said user codes and allows the delivery of messages between said users.

### BACKGROUND OF THE INVENTION

From Neolithic times to Industrial Revolution (nineteenth century), people lived in small communities. These communities were stable, i.e. generally all members remained within their own community for their whole life. Therefore, they all knew each other.

From the first Industrial Revolution, people massively left their small communities and started concentrating around industrial centers, where people of different origin would group together. These industrial centers gradually consolidated, receiving an increasing number of people coming from ever more distant locations.

In this manner, and for the first time in the history of Humanity, people who did not know each other started sharing an environment, coincided in common places or simply crossed each other on the street; people who, although would have coincided in the past and would therefore recognize each other, would not have established any sort of relationship, or people who would have a superficial and merely formal relationship (such as neighbours, etc.) but who would not have each other's contact information.

A new group of people would thus be created in society, i.e. people unknown to each other within a same environment (Unknown to each other in a Common Environment) (UCE). People who do not know each other, who do not have a personal relationship, but who share a same environment, where they coincide regularly, occasionally or have coincided on one occasion.

In parallel, in these industrial centers a new social phenomenon emerges: “the uprooting”, caused by the feeling of not belonging of these people to the new environment, which together with the absence of acquaintances entails a peculiar feeling of loneliness, since this feeling occurs within a very populated community, i.e. loneliness surrounded by people.

The communication needs in this context therefore must necessarily be solved by the communication between people who do not know each other with whom they share their environment.

The former industrial centers have now become sophisticated hyper-populated urban centers, where the group of people unknown to each other in these environs has grown enormously, since the range of facets evolving in society has also widened enormously: work, leisure, sport, culture, transport, friendship relations, couple relations, etc.

We totally ignore the identity and contact information of the UCE, although we do have important information on each, i.e. a picture and the place where we coincide.

From the place where we coincide with other people, we can obtain interesting information about them, such as preferences, hobbies, interests, etc. For example, two people coincide in a museum because they have museums as a common hobby or interest, in the same way as when they coincide in a stadium, in a fitness club, school, etc.

In today's society, a visual representation of a person is one of the main information elements in the person's profile, which also allows to extract information about that person: social position, professional status, certain features of personality and especially, his/her physical attractiveness.

Therefore in our view a picture is indoubtedly the most decisive aspect when choosing to whom we wish to relate, in all cases and especially when we are thinking of a couple relationship.

Thus, in reality we do have knowledge of very valued and decisive aspects of the people who are unknown to us and live in our same real environment.

In today's population centers, UCEs form groups that are extense and varied enough so as to bring together an assemblage of interesting and attractive people with whom we could wish to communicate.

We are all aware of the moments of complicity and mutual attraction that may occur at any time between people who share an environment, and of the obstacles of direct, personal communication existing in society.

Among these obstacles, the most important are:
1.—Lack of privacy. We often find we are accompanied by acquaintances, relatives, friends or numerous other people unknown to us who are around when we meet with the unknown people we would like to communicate with.
2.—Fear of ridicule. Fear to possible mockery because of an attempt at communication that is rejected by an unknown person. 3.—An unwritten law says a person should not show personal interest or that he/she feels attracted to the other person. In the case of two people who coincide regularly or occasionally in a given environment and who feel attracted to each other or feel a mutual interest to know each other, they must avoid that both the other person and the rest of the environment perceives said interest, and consequently, this frustrates most possibilities of communication, or at least implies an unsurmountable obstacle for most people when trying to communicate with someone unknown.
4.—Pace of life. The haste and stress of daily activity do not generate the enabling environment for establishing a relationship with unknown people.

All these obstacles imply important barriers, generally permanent, to the possibilities of communication between unknown people, especially in couple relationships.

This is a perfectly known fact to which varied solutions have been contributed, among which the following may be mentioned:
A.—Dating agencies.
B.—TV and radio programs.
C.—Commercial premises with tables and chairs and a telephone on each table.
D.—Social networks.

Among the new services offered in social networks created over the past decade, we highlight as one of the most extended, that relative to personal relationships.

U.S. Pat. No. 6,269,369 describes a social network system that helps users to find and establish social relationships with other users, allowing users to identify other users based on, for example, their hobbies. The system also provides a mechanism for the user to establish social relationships in a selective manner, or connections to other users, as well as giving permits so those other users can see the personal information of the user. The system can also include features allowing users to identify the contacts of their respective contacts. Also, the system can notify users about the updates of personal information made by their respective contacts.

On the other hand, U.S. Pat. No. 7,069,308 describes a method and system for the connection of users of an online computer system based on their relationships within the social networks.

Also known from U.S. Pat. No. 7,752,553 is a method and system for providing a flux of aggregated events allowing to disclose said events to a user through a range of online services, such as a website, a client application or a mobile device. In particular, a screen provides the user with the events in stacked format such that each block of the stack represents one or more events origined in the user's own activities or origined in those of the contacts of the user within his/her social network; the activities can origin from accounts in other online services the user has linked to his/her own account or profile, updating the stacked format in real time so the user may form an impression of the activities in his/her social network.

Likewise, the provisional patent application U.S. 60/753,810 describes a system and method managing information about the relationships in a social network through a timeline.

According to the state of the art, in a first classification, the social networks can be divided into two large groups:
D.1.—Friendship-oriented. Their main aim is to provide a technological structure facilitating relationships between people who known each other or known by their acquaintances. They allow to enhance relationships between people who know each other and to establish new relationship with people known by their acquaintances.
D.2.—Those oriented to couple relationships (dating). They are databases containing user profiles and which are available to users. They are designed fundamentally to generate couple relationships between users of these services. They have specialized into a number of subtypes:
   D.2.1.—Matchmaking, which is defined as the creation of durable unions based on compatibility.
   D.2.2—Online dating, in contrast, relates to the rapid generation of casual contacts.
   D.2.3.—Speed-dating, organizes face-to-face datings in which single people of similar age have a limited time, generally not more than a few minutes, to talk and know each other.
   D.2.4.—Slow-dating, in contrast, gives priority to traditional datings between single people.

These solutions, especialmente those for facilitating the generation of new couple relationships, have serious disadvantages, such as:
1.—The confidentiality about the belonging to said environments is not possible, because said belonging is visible to any internet user (relatives, friends, work colleagues, intimate enemies, etc.) at any time.
2.—Often, users exist with profiles that are false, manipulated or of dubious credibility, wasting the time of other users, and potentially leading to unpleasant situations.
3.—There is a large percentage of users who have founded suspicions that the organizers themselves of these virtual environments are creating some of these “dubious” profiles with the only aim of extending the membership of the “paying” users in their platforms.
4.—The fact that all information in a profile (and each user generates a large amount of data), as well as intimate conversations of the user with other users, are available to who knows who, generates a certain feeling of insecurity among users of these environments. In addition to the acknowledged safety vulnerabilities in the custody of these data.
5.—Although they mean a considerable expense for many users, the degree of satisfaction they provide is very low, as they not only do not fulfill promised expectations, but frequently also lead to undesirable situations.

These communication solutions, in short, are nothing more but traditional dating agencies in which offices and books have been replaced by internet servers and electronic databases, but without the presence of the accountable person of old-style agencies, who acted as guarantors of the veracity of the users' profiles.

However, it is essential to understand a fundamental fact.
A. All known systems and methods have one characteristic in common: they are not a solution to communicate UCE, that is, they do not provide a solution that allows people sharing the environment to get in touch, but rather create new environments.
B. They do not allow to establish contact with a person with whom one has physically coincided in a same environment (restaurant, bus, fitness club, while having a walk, etc.) on a regular, occasional or unique basis.
C. They only create new environments. They create new groups of people and facilitate contact between them. That is, they are completely different systems, with different objectives and different disadvantages.
D. They acknowledge that they cannot provide a way for establishing contact with whom one really wants to contact. They offer several alternative profiles in case one is of interest.
By using these solutions one will never find the way for establishing contact with the person with whom one coincides occasionally on the bus or in the fitness club or one day in a museum. The user must accept that he/she can only look at the profiles offered in these sites and if any is interesting, trust that it will be real.
E. None of the abovementioned systems provides a solution for communicating UCE.

Therefore, the state of the art does not allow to solve the traditional demands for solutions that facilitate communication between people who do not know each other, within a real environment.

The method according to the present invention allows people unknown to each other who share an environment and who therefore have visual contact, to be able to establish contact through mobile telephone messages or e-mail, based on the perception of the user codes formed through the combination of graphic symbols that follow uniquely identifying coding rules for each user within the system, whereby the use of an application that decodes said physical elements allows to establish contact (telephonic or through the web) between users of said system.

### DESCRIPTION OF THE INVENTION

The method and system of communication object of the present application, solve the abovementioned disadvantages, also providing other additional advantages which will become evident from the description to follow.

The method according to the present invention allows people unknown to each other who share a physical environment (a restaurant, bus, fitness club, cinema, classroom, etc.), and who therefore have visual contact, to establish communication through SMS or electronic mail.

Likewise, it also allows people who, although known to each other, and who have a merely superficial and formal relationship, and therefore do not have each other's contact information, to establish communication through SMS or e-mail.

In addition, it also allow people who know each other and have each other's contact information, to establish discreet and private communication based on the anonymity of the sender, through SMS or e-mail.

In this way, the method of the present invention enables a user-1 of the system having visual contact with a user-2 of the system who carries in a perceptible manner a a registered user code that is specific to the system (formed by a chain of symbols) (FIG. 2), to contact with the latter through a SMS or electronic mail, also allowing the second user to respond to the message from the first user or to reject it.

The system is based on:
1.—A set of graphical symbols that are easy to identify, recognize and memorize, which therefore must be a representation of concrete elements or concepts that are familiar or known, and not abstract pictures that do not represent any element or concept. Among the available symbols in the system, several will also exist to identify the users, such as, for example, those graphical representations suggestive of hobbies, professions, horoscope, etc.
2.—Chains comprised of a subset from the set of graphical symbols available in the system. The symbols forming a chain could be repeated within the chain. Not so the chains, which are unrepeatable.

The number of symbols in the system and the maximum number of symbols that the chains can contain define the total number of possible chains and therefore the maximum number of system users. This number is determined by combinatorial laws, through permutation of X elements taken in groups of Y elements, wherein X is the maximum number of symbols in the system and Y is the maximum number of symbols in a chain.

Each user must select a set of graphical symbols to form a chain that constitutes the registered user code of a user. Said chain cannot have been selected previously by another user. Said chain will be associated to the user who configures it and will identify the user in an exclusive and unique way within the system.
3.—A physical element, which is the material embodiment of the chain of graphical symbols. It must be designed to be carried in a visible, natural and discreet way by the system's users. Therefore it must be manufactured so it can be mounted on everyday life articles, such as, for example, a necklace, a bracelet, a watch chain, a cap, etc. Said physical element will be selected by each user, both the chain of symbols composing it and the support on which said chain will be mounted. At the moment when the registration of each system user occurs, a manufacturing order is generated of the symbols and mounting on the support selected. Subsequently, this physical element will be sent to a distribution center chosen by the user, where it will be collected and paid on delivery.

A registered user code can also be produced in an electronic format, such as, for example, an electronic file containing the image of the chain of symbols forming the code of the registered user and that is used as a screen wallpaper or background image of a mobile telephone.
4.—The system according to the present invention is also based on a web-based computer system composed of:
   4.1.—A server containing a hard disk in which an application is implemented that is composed of a series of interfaces and programming code executing a number of functions. It also includes a database. The clients connect to said server through a modem and the communications protocol.
   4.2.—Interface-0. It collects the information of a user that gives access to the application resident in the server, i.e. the user's login and password.
   4.3.—Interface-1. Registration of new user (FIG. 3). It collects the information of the new system user, number of mobile telephone and e-mail address, as well as the chain of symbols that the new user wishes to use as identification within the system (FIG. 5), saving this information in an electronic database.
   To complete the registration process of the new user, the server sends an e-mail to the address indicated by the new user and a SMS to the number indicated by the new user. Said e-mail message contains a link to an url, which must be clicked on to continue the registration process. The SMS contains an alphanumerical code that must be sent by the new user to a telephone number indicated in order to complete the registration process.
   4.4.—An electronic database, whose records contain:
      4.4.1.—The contact information of each user (number of mobile telephone and e-mail address) and the chain of symbols chosen by the new user.
      4.4.2.—The database also contains one record for each of the communications produced between users, that is, the emitting user, the receiver, the date and time of the communication and the 140 first characters of the message.
   4.5.—Interface-2 (FIG. 7). Delivery of messages. Through which a user-1 of the system can introduce the chain of graphical symbols of a user-2 of the system and write a text he/she wishes to send to said user with whom he/she wishes to establish communication. Previously, this user-1 must have initiated a session with his/her information that gives access to the system. (FIG. 4)
   4.6.—Computer program 1 code that receives information through interface-2 and connects to the database. One of the information items of the interface-2 is the chain of symbols of user-2, which is related to the database containing the contact information of this user-2, which are thus found by the program code, i.e. the telephone number and the e-mail address. Another of the information items of the interface-2 is the message one wishes to send to user-2. Because contact information of user-2 are available, this computer program code sends the message to the mobile telephone and to the e-mail address of user-2.
   4.7.—An interface-3, displaying the list of messages sent by a system user, including the chain of symbols of the receiver user, the date and time of delivery and the message delivered.
   4.8.—Interface-4. It displays the list of messages received by a system user, including the chain of symbols of the origin user, the date and time of reception, and the message delivered.
   4.9.—Interface-5. It gives a user who has received a message the option to reject the messages of that user forever or to reply to said message automatically.
5.—Computer application implemented in a mobile telephone.
   5.1.—A server containing a hard disk in which an application is implemented composed of a series of interfaces and a program code executing several functions, including the mentioned database. The clients connect to said server through an application resident in a mobile telephone.
   5.2.—Interface-1 (FIG. 7). Asks for the chain of symbols of the receiver user and the message to be sent to said user.
   5.3.—Computer program code that connects with the database in the server, obtains the contact information of the receiver user and delivers the message to the receiver user.
   5.4.—Interface-2.—It gives a user who has received a message the option to reject the messages of that user forever or to reply to said message automatically.
   5.5.—Interface-3. Displays the messages delivered.
   5.6.—Interface-4. Displays the messages received.
   5.7.—Functionality that allows to detect, through wireless communication protocols such as, for example, bluetooth or wi-fi, the registered user codes in electronic format of users whose mobile telephones are within range of said devices and with activated communication permits, in addition to detecting and registering the registered user code, the application software for mobile telephone of a user imports an image located in a given folder in the mobile telephone of another connected user who has saved said image freely and that must correspond to the photograph of the user.

The method according to the present invention solves in a simple, effective and economical way the communication obstacle (between people known or unknown to each other who share an environment) that is posed by the unwritten rule in our society that prevents showing an interest for an unknown, although attractive person.

In addition, it has the advantage that in the management system, the only resident user information are mobile telephone numbers and electronic mail addresses; no names, postal addresses, ages, hobbies, bank details, etc. are included in the system.

This solution ensures maximum discretion during communication, both towards the rest of the environment and towards the user with whom it is desired to establish contact, as it allows communication to occur in the desired place and time, also allowing, in an initial phase, to send messages in an anonymous manner, testing in this way the receptivity of the other person.

The method and system of communication allowing people who have visual contact to communicate through SMS or e-mail by use of the identification based on a registered user code having a physical or electronic format and a web-based software, according to the present invention, allows a user-1 of the system who has visualized an identifier code of a user-2 of the system, to deliver a message that will be received by electronic mail or sms.

### BRIEF DESCRIPTION OF DRAWINGS

To complement the above description and with an aim to helping to a better understanding of the features of the invention, a detailed description of the preferred embodiment is provided, based on a set of drawings attached to this descriptive specification and wherein, in a merely orientative and never limiting sense, the following has been represented:

FIG. 1 shows a diagram of the method and system of communication between two users according to the present invention.

FIG. 2 shows a possible combination of physical elements identifying the user, which can be displayed, for example, hanging from a necklace, bracelet, pin, etc.

FIG. 3 shows the user registration screen in the application.

FIG. 4 shows the screen of confirmation of user registration.

FIG. 5 shows the screen of creation of the image chain identifying each user.

FIG. 6 shows the confirmation of the creation of the image chain identifying the user.

FIG. 7 shows the screen of creation and delivery of a message according to the present invention.

FIG. 8 shows the screen of confirmation of message delivered.

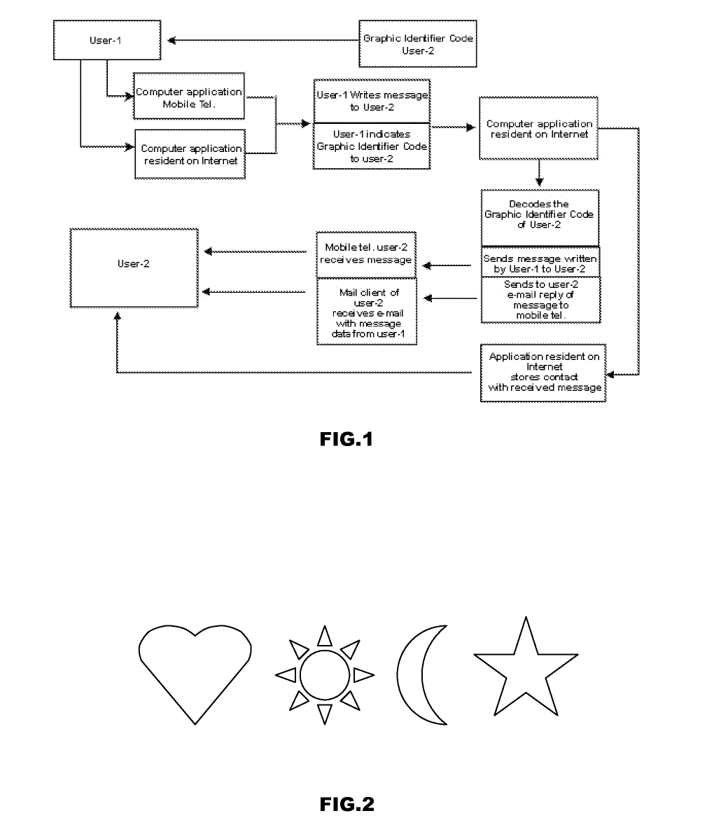

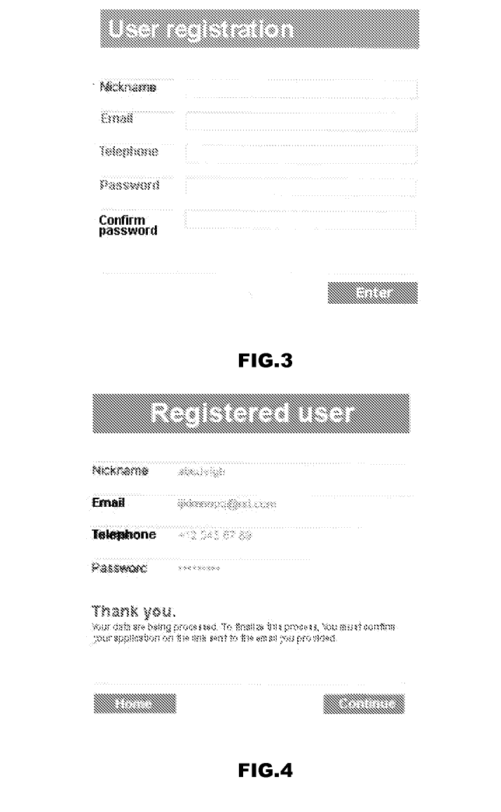

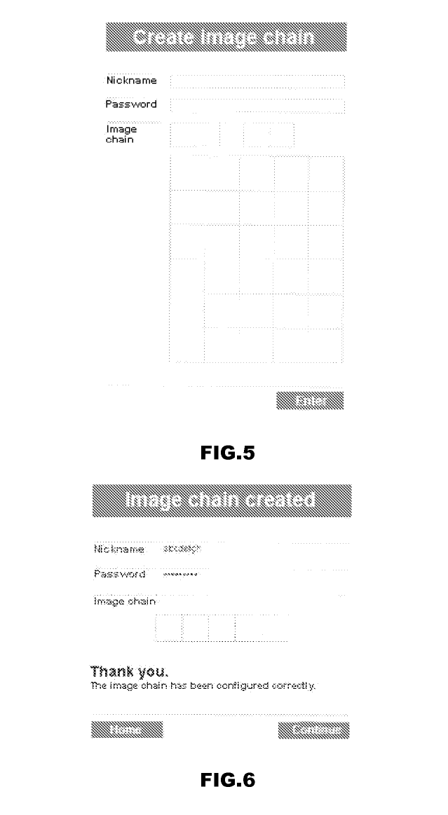

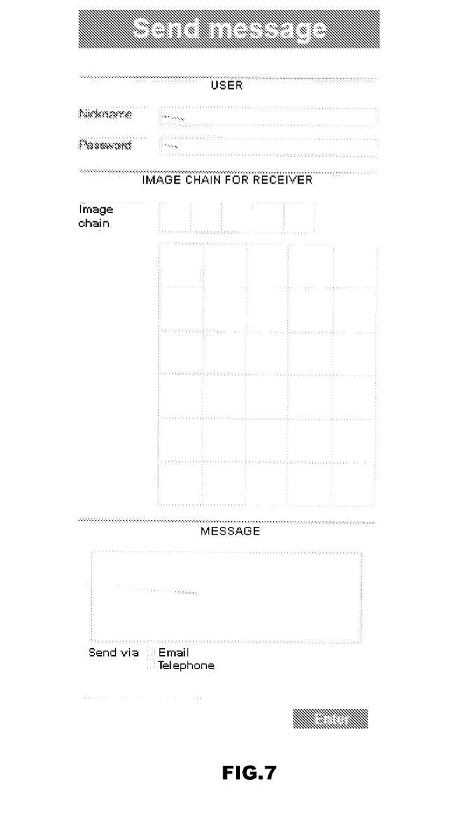

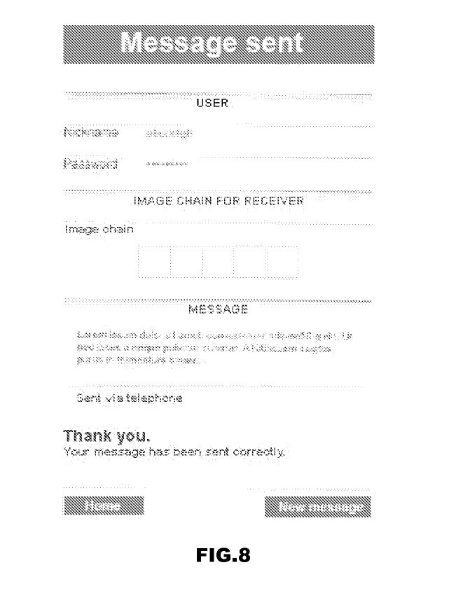

1. Method and system of communication between people unknown to each other who have visual contact, based on the perception of a registered user code and a web-based software, wherein they allow unknown people who on a certain occasion coincide in a same physical environment and who therefore have visual contact, but who, obviously because of the fact they do not know each other, do not have the other's contact information, specifically the other's telephone number and e-mail address, to establish communication through SMS and e-mail messages, by using a registered user code providing each user with an exclusive identification of registered user, and also using a computer system including a server and a database of registered users that stores for each user an exclusive identification of registered user and his/her contact information, more specifically, his/her mobile telephone number and e-mail address.

2. Method and system of communication between people unknown to each other who have visual contact, based on the perception of a registered user code and a web-based software according to claim 1, wherein each user must carry in a manner perceivable by others a registered user code composed of a unique chain of symbols, which identifies exclusively the user as registered user within the system.

3. Method and system of communication between people unknown to each other who have visual contact, based on the perception of a registered user code and a web-based software according to claim 2, wherein the chain of symbols identifying each user is selected by the user from among the chains available in the system, i.e. those not selected previously by any other user.

4. Method and system of communication between people unknown to each other who have visual contact, based on the perception of a registered user code and a web-based software system according to claim 2, wherein the registered user code that is identificative and exclusive for each user can be manufactured on different supports, with different dimensions and materials, preferably in the form of a necklace, bracelet, pin or any other equivalent embodiment.

5. Method and system of communication between people unknown to each other who have visual contact, based on the perception of a registered user code and a web-based software according to claim 2, wherein the registered user code that is identificative and exclusive for each user can be produced in electronic format, preferably an image of a chain of symbols forming the registered user code and that can be used as a screen wallpaper or background image of a mobile telephone.

6. Method and system of communication between people unknown to each other who have visual contact, based on the perception of a registered user code and a web-based software according to claim 1, wherein each user can send an SMS and/or e-mail to another user who carries in a perceivable manner his/her registered user code which exclusively identifies him/her as registered user through a computer system implemented on an internet server or on a mobile telephone.

7. Method and system of communication between people unknown to each other who have visual contact, based on the perception of a registered user code and a web-based software according to claim 6, wherein the computer system or application in the mobile telephone comprises a graphic interface where a message is introduced of maximum 140 characters to be delivered to another user after introducing the symbols forming the chain of the registered user code that is the exclusive identifier of the user who is the receiver of the message.

8. Method and system of communication between people who are unknown to each other who have visual contact, based on the perception of a registered user code and a web-based software according to claim 6, wherein the computer system of application in a mobile telephone detects through wirelss communication protocols such as, for example, bluetooth or wi-fi, the registered user codes in electronic format of users whose mobile telephones are within range of said devices and with activated communication permits, and in addition to detecting and registering the registered user code, the application software for mobile telephone imports an image located in a given folder in the mobile telephone of another connected user who has saved said image freely and that must correspond to the photograph of the user.

9. Method and system of communication between people unknown to each other who have visual contact, based on the perception of a registered user code and a web-based software according to claim 1, wherein the computer system comprises an application implemented on an internet server that connects the graphic interface to a database containing the information of the registered users (the chains of symbols that identifying them in an exclusive manner within the system, their telephone numbers and their e-mail addresses), obtains the contact information of the receiver user included in the graphic interface and delivers the message to the mobile telephone and/or e-mail address of the user.

10. Method and system of communication between people unknown to each other who have visual contact, based on the perception of a registered user code and a web-based software according to claim 1, wherein the receiver user of the messages receives a SMS and/or an e-mail with a message of maximum 140 characters and as sender, the chain of symbols of the sender user.

11. Method and system of communication between people unknown to each other who have visual contact, based on the perception of a registered user code and a web-based software according to claim 1, wherein the receiver user can block the reception of messages via SMS and e-mail from another user to his/her mobile telephone and e-mail address.

12. Method and system of communication between people unknown to each other who have visual contact, based on the perception of a registered user code and a web-based software according to claim 1, wherein the receiver user can block the delivery of messages via SMS from another user to his/her mobile telephone.

13. Method and system of communication between people unknown to each other who have visual contact, based on the perception of a registered user code and a web-based software according to claim 1, wherein the receiver user can block the delivery of messages via e-mail from another user to his/her e-mail address.

14. Method and system of communication between people unknown to each other who have visual contact, based on the perception of a registered user code and a web-based software according to claim 1, wherein the computer system is provided with a list of past messages showing the user all messages sent, including date and time of delivery, the chain of symbols of the receiver and the message.

15. Method and system of communication between people unknown to each other who have visual contact, based on the perception of a registered user code and a web-based software according to claim 1, wherein the computer system is provided with a list of past messages showing the user all messages received, including date and time of delivery, the chain of symbols of the sender and the message.
